(19) United States
(12) Patent Application Publication
(10) Pub. No.: US 2004/0217734 A1
(43) Pub. Date: Nov. 4, 2004

(54) BATTERY CHARGER CIRCUIT

(76) Inventor: King Mo Shum, Kowloon (HK)

Correspondence Address: KAPLAN & GILMAN , L.L.P., 900 ROUTE 9 NORTH, WOODBRIDGE, NJ, 07095, US

(21) Appl. No.: 10/426,215

(22) Filed: Apr. 30, 2003

(51) Int. Cl. H02J 7/00

(52) U.S. Cl. 320/116

(57) ABSTRACT

A battery charger having a plurality of series connected sections for serially charging a plurality of rechargeable batteries, for example rechargeable batteries of AA or AAA size. Each charging section includes a charging path for a battery and a parallel bypass path for bypassing a battery when it is fully charged. The charging path and the bypass path of each charging section each include an electrically operable switching device, which devices are preferably MOSFETs. Control circuitry is included to ensure one switching device is off when the other is on. MOSFET switching devices are connected into the circuit in directions to ensure they are not burnt out by the charging currents. A discharge circuit may be included for the batteries to discharge briefly between pulses of charging current thereby providing for “negative pulse charging” of the batteries. The charger provides for improved efficiency of charging in that very little power is consumed by the switching devices in the charging paths.

### BACKGROUND

The present invention relates to a battery charger having a plurality of series connected charging sections for charging a plurality of rechargeable batteries.

Series charging is typically used for simultaneously charging a plurality of rechargeable batteries of small voltage, for example batteries of AA or AAA size, typically of 1.2 to 2 volts terminal voltage. This is because it allows for fast charging and requires a power supply of lesser current rating than would be required for a charger that is arranged to charge the batteries in parallel. However series charging presents problems in that if a battery is removed from the charging circuit, the series circuit will be broken and charging will cease, or if a battery is fully charged before others in the series, it may be damaged or destroyed by continued passage of the charging current through it. Thus battery chargers for series charging of a plurality of batteries need to provide for individual batteries in the series circuit to be by-passed by the charging current.

Hong Kong Short-Term Patent No. 1045076, entitled “An Intelligent Serial Battery Charger and Charging Block”, discloses a serial battery charger including a number of serially connected battery charging sections in which each battery charging section is characterised by a first and a second parallelly connected branch. The first branch includes terminals for connecting to the battery to be charged and a current blocking device, and the second branch includes a by-passing switch which shunts across the terminals of the first branch when activated. The blocking device in the first branch prevents adverse reverse current flow from the battery to the charger when there is no power supply and also functions as a current block to prevent adverse flow of current from the battery into the shunting by-passing switch when the power supply to the charging section is in operation. In this disclosure the current blocking device (claimed as “a one-way electronic device”) is a diode and more specifically, in practical embodiments of the development, a Schottky-barrier diode, and the by-passing switch is a FET, more specifically a MOSFET. This patent specifically states that a MOSFET is not suitable for the current blocking “one-way electronic device”. Thus the charging circuit of this Hong Kong patent is limited to the combined use of a diode as the “one-way electronic device” for current blocking in its first (charging) parallel branch of the circuit and a MOSFET (an “electronically controllable by-passing switch”) in the second (by-passing) parallel connected branch. Limitations of this disclosed charging circuit are that when charging a battery, the diode consumes a relatively large amount of the available power thereby slowing the charging rate compared to what might otherwise be possible. Furthermore, the diode, being a one-way device, does not readily provide for a circuit configuration allowing for a discharge current to flow from a battery, as in for example a charger providing for negative pulse charging of a battery.

An object of the present invention is to provide a battery charger having a plurality of series connected charging sections for charging a plurality of rechargeable batteries which is improved compared to the above identified Hong Kong patent. There are two main improvements which may be separately realised in different embodiments of the invention. The first is that components may be used in the charging sections of the battery charger circuit that consume less power than a diode. The second is that such components also facilitate the provision of an embodiment that provides for negative pulse charging.

### SUMMARY OF THE INVENTION

The present invention provides a battery charger having a plurality of series connected charging sections for charging a plurality of rechargeable batteries, wherein each charging section comprises a charging path for a charging current to flow through a battery connected into the charging path, and

a by-pass path for the charging current to by-pass the charging path when a battery connected therein is fully charged. The charging path and the by-pass path each include in series therewith an electrically operable switching device, which is preferably a solid state device, for example each device may be a FET or preferably a MOSFET. The charger furthermore includes control circuitry for operating the two electrically operable switching devices of each charging section. The switching devices of each charging section are operated such that when one is conductive the other is non-conductive. Generally the switching device in the charging path of a charging section will be conductive whilst the switching device in the by-pass path of that charging section is non-conductive for passage of the charging current through a battery in the charging path and not through the by-pass path, and to prevent any discharge current from the battery from passing through the by-pass path upon cessation of the charging current. For by-passing a battery that is fully charged in a charging section, the switching device in the charging path of that charging section will be non-conductive whilst the switching device in the by-pass path of that charging section will be conductive for the charging current to by-pass the charging path and thus the battery.

Preferably the control circuitry includes a micro-processor for providing control signals for effecting operation of the switching devices of each charging section to render them either conductive or non-conductive. More preferably, with solid state switching devices, a single control signal is provided for each charging section, and this signal is effective to cause one of the switching devices of that charging section to switch on such that it is conductive and the other switching device to switch off such that it is non-conductive.

Preferably the charger further comprises a discharge circuit which can be opened or closed via the control circuitry, whereby when the switching device in the charging path of a charging section is conductive and the switching device in the by-pass path of that charging section is non-conductive, cessation of the charging current together with closure of the discharge circuit provides for a discharge current to flow from the battery through the switching device of that charging section and through the discharge circuit. For preceding charging sections in the series connected charging sections, the discharge current may flow through the switching device in the by-pass path of such preceding sections.

Generally the charger will include a constant current source which is switchable on and off via the control circuitry. Preferably the charger is operable for the constant current source to supply the charging current to a charging section in pulses having a long duty cycle and for the battery in that charging section to discharge between the charging pulses, the discharge periods having a short duration, thereby providing negative pulse charging of the battery.

The invention according to a preferred embodiment thereof provides for a two-way electrically controllable solid state switching device, most readily realised in a MOSFET, to be used instead of a one-way diode, that is a non-electronically controllable switching device as in the above mentioned Hong Kong patent. Contrary to the findings in that Hong Kong patent, it has been discovered that a MOSFET can be used to provide a blocking function in the charging path without burning out, as will be described in detail hereinbelow.

For a better understanding of the invention and to show how it may be carried into effect, preferred embodiments thereof will now be described, by way of non-limiting example only, with reference to the accompanying drawings.

### BRIEF DESCRIPTION OF DRAWINGS

FIG. 1 is an idealised current waveform illustrating negative pulse charging.

FIG. 2 is a battery charger circuit according to a preferred embodiment of the invention that employs N-channel MOSFETs as switching devices.

FIG. 3 is another embodiment of the invention which employs P-channel MOSFETs as switching devices; and

FIG. 4 is a further embodiment of the invention which employs relay-switches as switching devices.

### DESCRIPTION OF PREFERRED EMBODIMENT

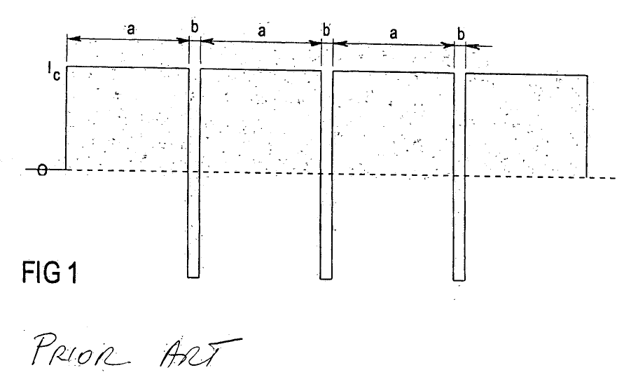

Negative pulse charging of a rechargeable battery facilitates fast and efficient charging of the battery. It involves a cyclic charging regime wherein a charging current I_{C} (see FIG. 1) is supplied to the battery for a specified time period ‘a’, following which the battery is allowed to discharge for a specified time period ‘b’, and this cycle is repeated until the battery is fully charged. Generally the discharge time period is short compared to the charging time period, for example, for a total one hour charging period, a cycle can consist of one second of charging followed by 0.1 second of discharging.

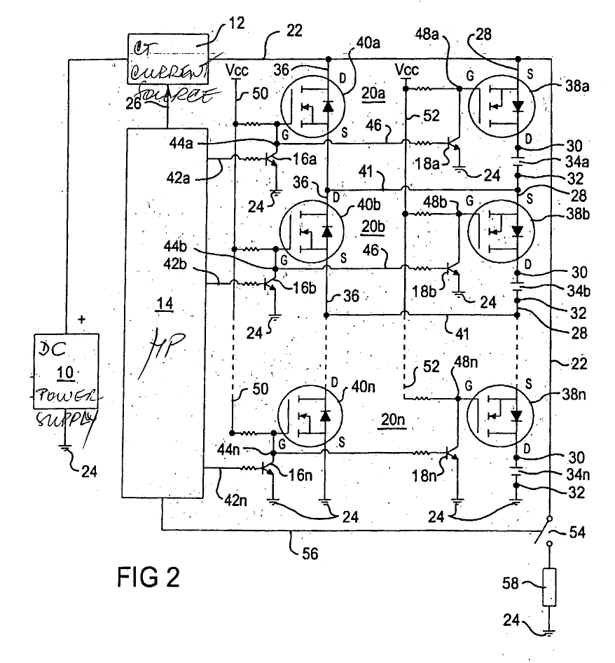

With reference to FIG. 2, a battery charger circuit according to an embodiment of the invention comprises a DC power source 10, a constant current source 12, a Microprocessor Control Unit 14 and other control circuitry including transistors 16a, 16b . . . 16n and 18a, 18b . . . 18n, and a plurality of charging sections generally referenced 20a, 20b . . . 20n (where ‘a’ signifies a first described integer and ‘n’ signifies a number n^{th} such integer). The charging sections 20a to 20n are connected in series, as described in more detail below. The constant current source 12 is connected to the positive of the main power source 10 and supplies charging current to the first of the series connected charging sections 20a along a line 22 under control of the Microprocessor Control Unit 14 via a signal on a control line 26. The negative of the power source 10 (and the current return paths) are illustrated as grounded, see reference 24.

Each charging section 20a, 20b . . . 20n comprises a charging path 28 (the first of which is connected to line 22), that includes contacts 30 and 32 for contacting the terminals of a battery 34 (respectively 34a, 34b . . . 34n) connectable into each charging section 20a, 20b, . . . 20n, and a bypass path 36 (the first of which is also connected to line 22). The charging path 28 of each charging section 20a, 20b . . . 20n includes in series therewith an electrically operable solid state switching device, namely an N-channel MOSFET, respectively 38a, 38b . . . 38n, connected such that charging current from line 22 flows through the N-channel MOSFETs respectively 38a, 38b . . . 38n in the source terminal to drain terminal direction (that is, in the forward direction of its internal diode) and through a battery, respectively 34a, 34b . . . 34n via respective pairs of contacts 30 and 32. Thus the source terminal S of the first MOSFET 38a is connected to line 22 and its drain terminal D is connected to contact 30 for contacting the positive terminal of the battery 34a. The source terminal S of the next MOSFET 38b is connected to the contact 32 for contacting the negative terminal of the battery 34a and its drain terminal D is connected to the contact 30 for contacting the positive terminal of the next battery 34b, and so on.

The by-pass path 36 of each charging section 20a, 20b . . . 20n also includes, in series therewith, an electrically operable solid state switching device, namely an N-channel MOSFET respectively 40a, 40b . . . 40n, connected such that a charging current from line 22 when bypassing a charging path 28 flows through the respective N-channel MOSFETs 40a, 40b . . . 40n in the drain terminal D to source terminal S direction (that is, in the reverse direction of its internal diode). The charging path 28 and by-pass path 36 of each charging section 20a, 20b, 20n, are connected in parallel by a line 41 connected between the negative battery contact 32 and source terminal S of the by-pass path MOSFET 40 of that charging section 20. Thus the charging sections 20a, 20b . . . 20n are series connected and each charging section comprises parallely connected charging and by-pass paths 28 and 36.

Control circuitry comprising the Microprocessor Control Unit 14 and, for each charging section 20a, 20b . . . 20n, a pair of switching transistors respectively 16a and 18a, 16b and 18b, . . . 16n and 18n, operates the N-channel MOSFETs 38 and 40 of each charging section by providing signals to influence the voltage levels at their gate terminals to either switch a MOSFET on, that is render it conductive, or switch the MOSFET off, that is render it non-conductive. The Microprocessor Control Unit 14 has a number of control line outputs 42a, 42b . . . 42n, one for each respective charging section 20a, 20b, . . . 20n. Each control line output 42 is connected to the base of the first switching transistor 16 for a charging section 20. The collector of the transistor 16 is connected to the gate terminal of the MOSFET 40 of the by-pass path 36 of that charging section 20, that is, at a circuit point referenced 44, (respectively 44a, 44b . . . 44n for the charging sections 20a, 20b . . . 20n) and the emitter of the transistor is grounded at 24. The collector circuit point 44 of the transistor 16 is also connected to the base of the switching transistor 18 via a line 46. The collector of the switching transistor 18 is connected to the gate terminal of the MOSFET 38 of the charging path 28 of that charging section 20, that is, at a circuit point referenced 48 (respectively 48a, 48b . . . 48n) and the emitter of the transistor 18 is grounded at 24. The gate terminals of the MOSFETs 38 and 40 are also connected to a circuit control or reference voltage Vcc via lines referenced 50 and 52. As is known, appropriate resistors are included in the base circuits of the transistors 16 and 18 and gate circuits of the MOSFETs 38 and 40.

The charger circuit also includes a discharge circuit which is a continuation of line 22 to a switch 54 which is closable and openable under a control signal from Microprocessor Control Unit 14 supplied via a line 56 to, respectively, connect and disconnect a resistive load 58 into and out of the discharge circuit. The discharge circuit is completed by connection of the other side of the resistive load 58 to ground at 24.

Before describing the operation of the overall charging circuit, it will be convenient to describe the operation of a switching transistor pair 16-18 for switching the N-channel MOSFETs 40 and 38 on and off. With reference to the first charging section 20a, a high signal on control line 42a will switch on transistor 16a which will cause a low voltage at circuit point 44a and thereby switch off the MOSFET 40a because the voltage at its gate terminal is low. Thus MOSFET 40a is rendered non-conductive. Simultaneously the low voltage at circuit point 44a will switch off the transistor 18a thereby causing a high voltage at circuit point 48a which will switch on the MOSFET 38a because the voltage at its gate terminal is high. Thus the MOSFET 38a will be rendered conductive. Conversely, a low voltage signal on control line 42a will switch off the transistor 16a, thereby causing a high voltage at circuit point 44a and switching on the MOSFET 40a, and simultaneously switching on the transistor 18a, which will cause a low voltage at circuit point 48a and thus switching off of the MOSFET 38a. When the MOSFET 38a is on, charging current from line 22 will flow in path 28 (note that switch 54 of the discharge circuit will be open) through the MOSFET 38a and battery 34a to charge the battery, whilst MOSFET 40a which is off and thus non-conductive, will prevent the charging current from by-passing the charging path 28. When the battery 34a is fully charged, MOSFET 38a is switched off and MOSFET 40a is switched on such that the charging current then flows through by-pass path 36 and through either the following MOSFET 40b or MOSFET 38b depending on which one is conductive and which is non-conductive.

Operation of the charging circuit when charging all batteries 34a, 34b . . . 34n will now be described. During a charging period ‘a’ (see FIG. 1) a high signal on control line 26 of Microprocessor Control Unit 14 switches on the constant current source 12 such that a charging current Ic can flow in line 22. The Microprocessor Control Unit 14 also outputs a high signal on lines 42a, 42b . . . 42n, which (as described hereinabove) switches by-pass path MOSFETs 40a, 40b . . . 40n off and charging path MOSFETs 38a, 38b . . . 38n on. The Microprocessor Control Unit 14 also outputs a low signal on line 56 which opens the switch 54 such that no current can flow through the discharge circuit. Thus the charging current Ic flows from constant current source 11 through line 22 and through the charging paths 28 of each charging section, that is, through MOSFET 38a, battery 34a, MOSFET 38b, battery 34b . . . MOSFET 38n, battery 34n, thereby charging the batteries. During a discharging period ‘b’ (see FIG. 1), Microprocessor Control Unit 14 outputs a low signal on control line 26 which switches off the constant current source such that no charging current Ic can flow. High signals are maintained on control lines 42a, 42b . . . 42n such that the by-pass path MOSFETs 40a, 40b . . . 40n remain off and the charging path MOSFETs 38a, 38b . . . 38n remain on. The Microprocessor Control Unit 14 also outputs a high signal on control line 56 which closes switch 54 to complete the discharge circuit. Because the charging path MOSFETs 38a, 38b . . . 38n remain on, there is a low impedance path across each from the drain to the source terminals whereby a discharge current can flow from the positive terminal contacts 30 of the batteries 34a-34n through charging paths 28 including MOSFETs 38n . . . 38b, 38a (that is, in reverse direction to the charging current flow) to line 22 through switch 54 and load 58.

If one of the batteries 34a, 34b . . . 34n becomes fully charged before the others, the charging circuit operates to by-pass that battery and continue charging the others. The fully charged status of a battery may be detected by appropriate circuitry (not shown) for detecting when a battery reaches a predetermined temperature, as is known. Assuming battery 34b is detected as fully charged, during a charging period ‘a’, the Microprocessor Control Unit 14 outputs a low signal on control line 42b which (as described hereinabove) switches by-pass path MOSFET 40b on and charging path MOSFET 38b off. This causes the charging current Ic to flow from battery 34a, through paralleling connection 41, through MOSFET 40b (from its drain to its source terminals' direction), through the next paralleling connection 41 to the charging path 28 of the next charging section 20n, that is through MOSFET 38n and battery 34n. Thus the by-pass path 36 of charging section 20b acts to by-pass or shunt the charging current Ic due to the low impedance in by-pass path 36 provided by the MOSFET 40b and the high impedance blocking provided in charging path 28 by MOSFET 38b. During a discharge period ‘b’, constant current source 12 is turned off and switch 54 closed by Microprocessor Control Unit 14 as before, however the discharge path now comprises battery 34n, MOSFET 38n, connection 41, MOSFET 40b (in the source to drain direction) connection 41, battery 34a, MOSFET 38a, line 22, switch 54 and load 58. It will be evident from the above explanation how the charging circuit operates if any other battery or more than one of the batteries become fully charged whilst others are still being charged until they all become fully charged, at which stage a cut-out (not shown) can operate to maintain the constant current source 12 off.

The N-channel MOSFETs 38a, 38b . . . 38n of the charging paths 28 are connected such that the charging current passes through them when they are switched on in the direction of their source terminal to drain terminal. It has been found that the MOSFETs 38a, 38b . . . 38n when so connected do not burn out. For example, if the MOSFET 38a is connected with its drain to line 22 and its source to contact 30 (i.e. the other way around), then when the by-pass MOSFET 40a is on, the MOSFET 38a will be off but its internal diode will also be in a forward biased condition such that a current path can be established from the positive terminal of battery 34a through the internal diode of the MOSFET 38a and the switched-on MOSFET 40a to the negative terminal of battery 34a. Since MOSFET 40a has a low impedance when switched on, and the nominal voltage of battery 34a upon fully charged is around 1.2 V, but the nominal voltage drop of a forward biased diode is only about 0.7 V, a large current will be generated through the said current path. Such a current will cause the N-channel MOSFET 38a if connected the other way around to that illustrated in FIG. 2 to burn out. The configuration of the two N-channel MOSFETS 38 and 40 of each charging section 20a, 20b . . . 20n prevents such burn outs.

An embodiment of the invention according to FIGS. 1 and 2 offers greater efficiency when charging compared to the prior art circuit of the Hong Kong Patent. For example, for a one hour charger with a charging current of 2 Amps, when using a MOSFET with internal resistance R_{DS-ON} of 0.015 ohms in the charging path as in FIG. 2, the power loss on one MOSFET device as given by its forward impedance times the current squared is: 0.015 ohms×2 Amps×2 Amps=0.06 watts. In contrast the power loss on one device when that device is a Schottky barrier diode as in the Hong Kong Patent, the power loss as given by the voltage drop across that device times the current is 0.5 v.×2 Amp=1.0 watts. Thus there is only a 6% power loss per device in the charging path in the circuit of FIG. 2 compared to the one-way diode device in the charging paths of the circuit of the Hong Kong Patent.

A further advantage is that the circuit of FIG. 2 offers the possibility of providing for negative pulse charging because of the possible two-way current flow through the MOSFETs, with the addition of minimal further components. That is, fundamentally only two extra components namely switch 54 and load 58 need be provided.

If a negative pulse charging regime is not required, the discharge circuit 22-54-58 may be omitted. Thus the provision of a discharge circuit is an optional feature of the invention.

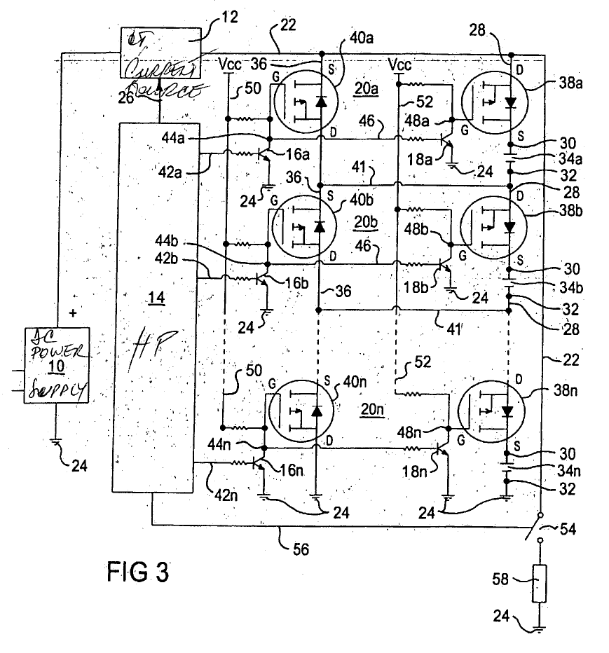

N-channel MOSFETs instead of P-channel MOSFETs are preferably used because they are generally less expensive. However P-channel MOSFETS may be used if desired. FIG. 3 illustrates a circuit in which P-channel MOSFETS have been used to provide the electrically operable switching devices in the charging and bypass paths. The FIG. 3 circuit is generally equivalent to that of FIG. 2 and thus the same reference numerals are used to indicate corresponding components. Persons skilled in the art will, in light of the description provided above of the functioning of the FIG. 2 circuit, readily understand the functioning of the FIG. 3 circuit and thus further description thereof is unnecessary. As in the FIG. 2 circuit, charging current in the charging paths 28 flows through the P-channel MOSFETs 38 in a direction that corresponds to the forward direction of their internal diodes, and the charging current when flowing in the bypass paths 36 flows through the P-channel MOSFETs 40 in a direction that corresponds to the reverse direction of their internal diodes (as is known, the current does not actually flow through the internal diode of a MOSFET).

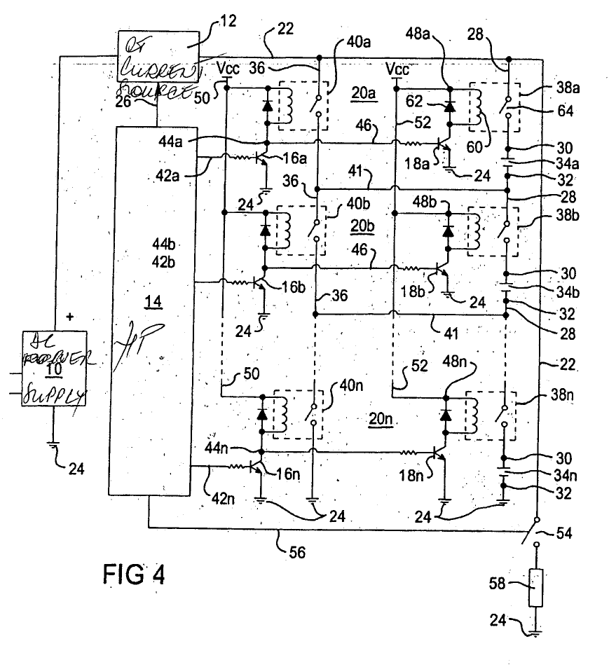

Also, electrically operable switching devices other than the MOSFETs 38 and 40 may be provided. For example, non-solid state switching devices such as relay switches may be used. Persons skilled in the art will readily be able to provide appropriate control circuitry to operate the coils of the relays. For example, FIG. 4 illustrates a circuit which is generally equivalent to the FIG. 2 and 3 circuits, but in which the MOSFETS are replaced by relay switches. Reference numerals the same as used in FIG. 2 have again been used for corresponding componentry to illustrate the equivalency of the circuits. Thus in the FIG. 4 circuit, relay switches 38a, 38b . . . 38n and 40a, 40b . . . 40n are used. Each such relay switch comprises (as referenced for relay switch 38a) an operating coil 60 bridged by a diode 62 and connected to the switching transistors 16 and 18 for operation thereby. As is known, when current flows through a coil 60 it causes the relay contacts 64 to close.

The invention described herein is susceptible to variations, modifications and/or additions other than those specifically described and it is to be understood that the invention includes all such variations, modifications and/or additions which fall within the scope of the following claims.

1.-12. (cancelled)

13. A battery charger having a plurality of series connected charging sections for charging a plurality of rechargeable batteries, each charging section including contacts for contacting the terminals of a battery to be charged,
the charger including a constant current source that is switchable on and off for providing a charging current in pulses, each charging section comprising
(i) a charging path that includes the contacts and a first MOSFET which is connected for the charging current to flow through it in a direction that corresponds to the forward direction of its internal diode and through a battery,
(ii) a by-pass path that includes a second MOSFET which is connected for the charging current to flow through it in a direction that corresponds to the reverse direction of its internal diode, the charger further comprising a discharge path including a switch for opening and closing the discharge path,
and control circuitry for switching the constant current source on and off, for rendering the first and second MOSFETs of each charging section conductive or non-conductive, and for opening and closing the switch of the discharge path,
whereby for charging a battery in a charging section, the first MOSFET of that charging section is rendered conductive and the second MOSFET non-conductive for the charging current to flow through the charging path and not the by-pass path and, during each off period of the pulsed charging current during which period the switch of the discharge path is closed, for a discharge current to flow from the battery to the first MOSFET and through the discharge path, thereby providing negative pulse charging of the battery.

14. The battery charger as claimed in claim 13 wherein the control circuitry provides for any one of the charging sections of the plurality of series connected charging sections to be by-passed by the charging current by rendering the first MOSFET of that charging section non-conductive and the second MOSFET conductive, and wherein the discharge path is structured to include the second MOSFET of a charging section in which the charging current by-passes the battery.

15. The battery charger as claimed in claim 13 wherein the first MOSFET is an N-channel MOSFET and the charging current flows through it in the source to drain direction, and wherein the second MOSFET is an N-channel MOSFET and the charging current flows through it in the drain to source direction.

16. A battery charger having a plurality of series connected charging sections for charging a plurality of rechargeable batteries, wherein each charging section comprises a charging path for a charging current to flow through a battery connected into the charging path, and
a by-pass path for the charging current to by-pass the charging path when a battery connected therein is fully charged,
wherein the charger further includes a discharge path for a discharge current to flow from the plurality of batteries upon cessation of the charging current,
wherein the charging path of each charging section includes an N-channel MOSFET connected such that the charging current flows through the MOSFET from its source terminal to its drain terminal,
wherein the by-pass path of each charging section includes an N-channel MOSFET connected such that the by-passed charging current flows through the MOSFET from its drain terminal to its source terminal,
wherein the charger further includes control circuitry for controlling a voltage applied to the gate terminal of each MOSFET such that when one MOSFET is conductive the other is non-conductive,
whereby
(i) for a battery connected into a charging section and undergoing charging, the MOSFET in the charging path of that charging section is conductive whilst the MOSFET in the by-pass path is non-conductive and, upon cessation of the charging current, the discharge path includes the conductive MOSFET in the charging path of that charging section, and
(ii) for a battery connected into a charging section and fully charged, the MOSFET in the charging path of that charging section is non-conductive whilst the MOSFET in the by-pass path is conductive and, upon cessation of the charging current, the discharge path includes the conductive MOSFET in the by-pass path of that charging section.

17. The battery charger as claimed in claim 16 wherein the charger includes constant current source for providing the charging current and is switchable on and off via the control circuitry, and the discharge path includes a switch for opening and closing the discharge path via the control circuitry, wherein the control circuitry is operable such that when the constant current source is switched off, the switch of the discharge path is closed for a discharge current to flow until the constant current source is switched on accompanied by the switch of the discharge path being opened.

18. A battery charger, comprising:
a plurality of series connected charging sections for charging a plurality of rechargeable batteries, each charging section including contacts for contacting the terminals of a battery to be charged, each charging section including a charging path having the contacts for passage of a charging current through a battery and a by-pass path for the charging current to by-pass the charging path, the charging path and the by-pass path each having in series therewith an electrically operable switching device;
control circuitry for operating the two electrically operable switching devices of each charging section; and
a discharge circuit that can be opened or closed via the control circuitry, wherein:
the control circuitry is operative for the switching device in the charging path of a charging section to be conductive whilst the switching device in the by-pass path of that charging section is non-conductive for passage of the charging current through a battery in the charging path and not through the by-pass path and to prevent any discharge current from the battery from flowing through the by-pass path upon cessation of the charging current,
the control circuitry is operative for the switching device in the charging path of a charging section to be non-conductive whilst the switching device in the by-pass path of that charging section is conductive for the charging current to by-pass a battery in that charging section that is fully charged, and
the discharge circuit may be closed by the control circuitry such that a discharge current is permitted to flow from the battery through the switching device of that charging section and through the discharge circuit when the switching device in the charging path of a charging section is conductive, the switching device in the by-pass path of that charging section is non-conductive, and the charging current ceases.
